(19) United States
(12) Patent Application Publication
(10) Pub. No.: US 2008/0132615 A1
(43) Pub. Date: Jun. 5, 2008

(54) Self-extinguishing thermoplastic polyurethanes, a process for their production and their use

(75) Inventors: Henricus Peerlings, Solingen (DE); Juergen Winkler, Langenfeld (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/986,821

(22) Filed: Nov. 27, 2007

(30) Foreign Application Priority Data
Nov. 30, 2006 (DE) 102006056522.3

(51) Int. Cl. C08L 75/04; C08K 5/3432; C08K 5/51

(52) U.S. Cl. 524/100

(57) ABSTRACT

The present invention relates to self-extinguishing thermoplastic polyurethanes, a process for their production and their use.

### FIELD OF THE INVENTION

The present invention relates to self-extinguishing thermoplastic polyurethanes, a process for their production and their use.

### BACKGROUND OF THE INVENTION

Thermoplastic polyurethanes (TPUs) are of great industrial significance because of their good elastomer properties and thermoplastic processability. Kunststoff Handbuch [G. Becker, D. Braun], volume 7 “Polyurethane”, Munich, Vienna, Carl Hanser Verlag, 1983, gives an overview of the production, properties and applications of TPUs.

TPUs are mostly composed of linear polyols (macrodiols) such as polyester diols, polyether diols or polycarbonate diols, organic diisocyanates and short-chain, mostly difunctional alcohols (chain extenders). They can be produced continuously or discontinuously. The best-known production processes are the belt process (GB-A 1 057 018) and the extruder process (DE-A 19 64 834).

The thermoplastically processable polyurethane elastomers can be constructed either step-wise (prepolymer metering process) or by the simultaneous reaction of all components in one stage (one-shot metering process).

A disadvantage of TPUs is their high flammability. To reduce this disadvantage, flame retardants, such as for example halogen-containing compounds, are incorporated with the TPUs. The addition of these products, however, in many cases has a negative effect on the mechanical properties of the TPU molding compositions obtained. Also, because of the corrosive effect of the halogen-containing substances, halogen-free self-extinguishing TPU molding compositions are desirable.

EP-B 0 617 079 describes the use of a combination of a phosphate and/or phosphonate with melamine cyanurate.

High requirements must be met especially if the TPUs are used in the electrical/electronics field, in particular in cables. Highly flammable, non-flameproofed polyolefin (e.g. polypropylene) is often used in cables, as a result of which the TPU has the problem in addition to its inherent flame resistance of also extinguishing this polyolefin. These high requirements, in particular with a thin wall thickness of the TPU sheathing with at the same time good extrudability, are not met by the known TPU materials.

### SUMMARY OF THE INVENTION

The present invention therefore provides self-extinguishing thermoplastic polyurethanes which are free from halogen-containing flame retardants as a cable sheathing material, which extinguish after ignition with a hot flame in a few seconds without burning and without producing droplets or without producing droplets when burning and thereby at the same time have good processing properties (good mechanical properties and good extrusion quality).

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

This problem could be resolved in that the TPU contains for flameproofing a mixture of organic incorporable phosphine oxides and melamine derivatives and optionally additional flame retardants.

The present invention therefore provides self-extinguishing thermoplastic polyurethanes which contain as a flame retardant at least one organic incorporable phosphine oxide and at least one melamine derivative, preferably melamine cyanurate and optionally additional flame retardants and optionally other additives and/or auxiliary substances.

The present invention further provides a process for the production of the self-extinguishing thermoplastic polyurethanes according to the invention wherein

A) organic and/or modified organic diisocyanates (a)

are reacted with

B) polyhydroxyl compounds (b), in particular substantially difunctional polyhydroxyl compounds and

C) chain extenders (c) in the presence of

D) flame retardants (d) and optionally

E) catalysts (e),

F) chain terminators (f)

G) auxiliary substances and/or additives (g)

wherein, at least one organic incorporable phosphine oxide and at least one melamine derivative, preferably melamine cyanurate and optionally additional flame retardants, are used as the flame retardant (d).

The melamine derivative can optionally also be added subsequently to the finished TPU by compounding.

The thermoplastic polyurethanes (also abbreviated to TPUs) are substantially linear thermoplastically processable polyurethanes.

It was surprising and in no way foreseeable that TPU molding compositions that in addition have very good mechanical, processing and application properties, could be obtained by the use of organic incorporable phosphine oxides in combination with melamine derivatives.

All known TPUs that can be produced according to conventional processes are suitable in principle for the “flameproofing” according to the invention.

The TPUs are preferably constructed of the following components:

Aliphatic, cycloaliphatic, araliphatic, aromatic and heterocyclic diisocyanates or any mixtures of these diisocyanates can be used as organic diisocyanates (a) (cf HOUBEN-WEYL “Methoden der organischen Chemie”, volume E20 “Makromolekulare Stoffe”, Georg Thieme Verlag, Stuttgart, New York 1987, pp 1587-1593 or Justus Liebigs Annalen der Chemie, 562, pp 75 to 136).

In particular, the following can be named by way of example: aliphatic diisocyanates such as ethylene diisocyanate, 1,4-tetramethylene diisocyanate, 1,6-hexamethylene diisocyanate, 1,12-dodecane diisocyanate; cycloaliphatic diisocyanates such as isophorone diisocyanate, 1,4-cyclohexane diisocyanate, 1-methyl-2,4-cyclohexane diisocyanate and 1-methyl-2,6-cyclohexane diisocyanate and the corresponding isomer mixtures, 4,4′-dicyclohexylmethane diisocyanate, 2,4′-dicyclohexylmethane diisocyanate and 2,2′-dicyclohexylmethane diisocyanate and the corresponding isomer mixtures; in addition, aromatic diisocyanates such as 2,4-toluylene diisocyanate, mixtures of 2,4-toluylene diisocyanate and 2,6-toluylene diisocyanate, 4,4′-diphenylmethane diisocyanate, 2,4′-diphenylmethane diisocyanate and 2,2′-diphenylmethane diisocyanate; mixtures of 2,4′-diphenylmethane diisocyanate and 4,4′-diphenylmethane diisocyanate, urethane-modified liquid 4,4′-diphenylmethane diisocyanates or 2,4′-diphenylmethane diisocyanates, 4,4′-diisocyanatodiphenylethane-(1,2) and 1,5-naphthylene diisocyanate. 1,6-hexamethylene diisocyanate, 1,4-cyclohexane diisocyanate, isophorone diisocyanate, dicyclohexylmethane diisocyanate, diphenylmethane diisocyanate isomer mixtures with a 4,4′-diphenylmethane diisocyanate content of more than 96 wt. % and in particular 4,4′-diphenylmethane diisocyanate and 1,5-naphthylene diisocyanate are preferably used. The named diisocyanates can be used singly or in the form of mixtures with one another. They can also be used together with up to 15 mol % (calculated on total diisocyanate) of a polyisocyanate. However, at most as much polyisocyanate may be used that still produces a thermoplastically processable product. Examples of polyisocyanates are triphenylmethane4,4′,4″-triisocyanate and polyphenyl polymethylene polyisocyanates.

Polyhydroxyl compounds or polyols (b) are those with on average at least 1.8 to at most 3.0 Zerewitinoff-active hydrogen atoms and a number average molecular weight M̅ₙ of 450 to 10000, preferably 450 to 6000. As a result of production, these often contain small quantities of non-linear compounds. The expression “substantially linear polyols” is therefore often used. Polyester diols, polyether diols, polycarbonate diols or mixtures of these are preferred.

Suitable polyether diols can be produced by reacting one or more alkylene oxides with 2 to 4 carbon atoms in the alkylene radical with a starter molecule that contains two active hydrogen atoms bound. The following for example can be named as alkylene oxides: ethylene oxide, 1,2-propylene oxide, epichlorohydrin and 1,2-butylene oxide and 2,3-butylene oxide. Ethylene oxide, propylene oxide and mixtures of 1,2-propylene oxide and ethylene oxide are preferably used. The alkylene oxides can be used singly, alternating one after the other, or as mixtures. The following for example come into consideration as starter molecules: water, amino alcohols, such as N-alkyl-diethanolamines, for example N-methyl diethanolamine and diols such as ethylene glycol, 1,3-propylene glycol, 1,4-butanediol and 1,6-hexanediol. Mixtures of starter molecules can also optionally be used. Suitable polyetherols are furthermore the hydroxyl group-containing polymerisation products of tetrahydrofuran. Trifunctional polyethers in quantities of 0 to 30 wt. % based on the bifunctional polyethers can also be used, but at most in a quantity such that a still thermoplastically processable product is produced. The substantially linear polyether diols preferably have number average molecular weights M̅ₙ of 450 to 6000. They can be used both singly and in the form of mixtures with one another.

Suitable polyester diols can be produced for example from dicarboxylic acids with 2 to 12 carbon atoms, preferably 4 to 6 carbon atoms, and multivalent alcohols. The following for example come into consideration as dicarboxylic acids: aliphatic dicarboxylic acids such as succinic acid, glutaric acid, adipic acid, suberic acid, azelaic acid and sebacic acid, or aromatic dicarboxylic acids such as phthalic acid, isophthalic acid and terephthalic acid. The dicarboxylic acids can be used singly or as mixtures, e.g. in the form of a succinic, glutaric and adipic acid mixture. It can optionally be advantageous for the production of the polyester diols to use the corresponding dicarboxylic acid derivatives, such as carboxylic acid diesters with 1 to 4 carbon atoms in the alcohol radical, carboxylic acid anhydrides or carboxylic acid chlorides, instead of the dicarboxylic acids. Examples of multivalent alcohols are glycols with 2 to 10, preferably 2 to 6 carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol or dipropylene glycol. Depending on the desired properties, the multivalent alcohols can be used alone or in mixture with one another. Esters of the carbonic acid with the named diols, in particular those with 4 to 6 carbon atoms, such as 1,4-butanediol or 1,6-hexanediol, condensation products of Ω-hydroxycarboxylic acids such as Ω-hydroxycaproic acid or polymerisation products of lactones, e.g. optionally substituted Ω-caprolactones, are also suitable. Ethanediol polyadipates, 1,4-butanediol polyadipates, ethanediol-1,4-butanediol polyadipates, 1,6-hexanediol neopentyl glycol polyadipates, 1,6-hexanediol-1,4-butanediol polyadipates and polycaprolactones are preferably used as polyester diols. The polyester diols have number average molecular weights M̅ₙ of 450 to 10000 and can be used singly or in the form of mixtures with one another.

Chain extenders (c) have on average 1.8 to 3.0 Zerewitinoff-active hydrogen atoms and have a molecular weight of 60 to 400. They include, in addition to compounds having amino groups, thiol groups and carboxyl groups, those with two to three, preferably two hydroxyl groups.

Aliphatic diols with 2 to 14 carbon atoms, such as e.g. ethanediol, 1,2-propanediol, 1,3-propanediol, 1,4-butanediol, 2,3-butanediol, 1,5-pentanediol, 1,6-hexanediol, diethylene glycol and dipropylene glycol, are preferably used as chain extenders. Diesters of terephthalic acid with glycols with 2 to 4 carbon atoms, e.g. terephthalic acid-bis-ethylene glycol or terephthalic acid-bis-1,4-butanediol, hydroxyalkylene ethers of hydroquinone, e.g. 1,4-di(β-hydroxyethyl)-hydroquinone, ethoxylated bisphenols, e.g. 1,4-di(β-hydroxyethyl)-bisphenol A, (cyclo)aliphatic diamines such as isophorone diamine, ethylenediamine, 1,2-propylenediamine, 1,3-propylenediamine, N-methyl-propylene-1,3-diamine, N,N′-dimethylethylenediamine and aromatic diamines such as 2,4-toluylenediamine, 2,6-toluylenediamine, 3,5-diethyl-2,4-toluylenediamine or 3,5-diethyl-2,6-toluylenediamine or primary mono-, di-, tri- or tetra-alkyl-substituted 4,4′-diaminodiphenylmethanes, however, are also suitable. Ethanediol, 1,4-butanediol, 1,6-hexanediol, 1,4-di(β-hydroxyethyl)-hydroquinone or 1,4-di(β-hydroxyethyl)-bisphenol A are particularly preferably used as chain extenders. Mixtures of the above-named chain extenders can also be used. In addition, smaller quantities of triols can also be added. An incorporable phosphine oxide in combination with a melamine derivative can be used as the flame retardant (d).

The phosphine oxide has on average at least 1.5 and at most 3.0, preferably 1.8 to 2.5, particularly preferably 1.95 to 2.10, Zerewitinoff-active hydrogen atoms. These Zerewitinoff-active hydrogen atoms are preferably contained in hydroxyl and amine groups of alcohols or amines.

The phosphine oxide has a number average molecular weight M̅ₙ of 60 to 1000.

A compound of general formula (1) is preferably used as the phosphine oxide:

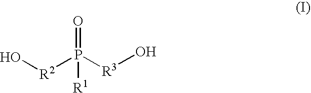

with
R¹=H, branched or unbranched alkyl radicals with 1 to 12 C atoms, substituted or non-substituted aryl radicals with 6 to 20 C atoms, substituted or non-substituted aralkyl radicals with 6 to 30 C atoms, substituted or non-substituted alkaryl radicals with 6 to 30 C atoms,
R², R³=branched or unbranched alkylene radicals with 1 to 24 C atoms, substituted or non-substituted alkarylene radicals with 6 to 30 C atoms, wherein R² and R³ can be the same or different.

The phospine oxide is preferably used in a quantity of 0.1 to 20, preferably I to 12, wt. %, based on the total quantity of TPU.

Melamine cyanurate is preferably used as the melamine derivative. The melamine cyanurate can be used in commercially available form.

Optionally, additional flame retardants (except melamine derivatives and phosphine oxides) such as e.g. phosphates and/or phosphonates can also be used. For an overview see e.g. Zweifel, Plastics Additives Handbook, 5^{th} ed, Hanser Verlag Munich, 2001, chapter 12; J. Green, J. of Fire Sciences, 1997, 15, pp 52-67 or Kirk-Othmer Encyclopedia of Chemical Technology, 4^{th} ed., vol. 10, John Wiley & Sons, New York, pp 930-998.

Suitable catalysts (e) are the usual tertiary amines known from the prior art, such as e.g. triethylamine, dimethylcyclohexylamine, N-methyl morpholine, N,N′-dimethyl piperazine, 2-(dimethylamino ethoxy)ethanol, diazabicylo[2,2,2]octane and similar, and in particular organic metal compounds such as titanic acid esters, iron compounds or tin compounds such as tin diacetate, tin dioctoate, tin dilaurate or the tin dialkyl salts of aliphatic carboxylic acids such as dibutyl tin diacetate or dibutyl tin dilaurate or similar. Preferred catalysts are organic metal compounds, in particular titanic acid esters, iron and tin compounds. The total quantity of catalysts in the TPUs according to the invention is as a rule approximately 0 to 5 wt. %, preferably 0 to 2 wt. %, based on the total quantity of TPU.

Monofunctional compounds with regard to isocyanates (f) can be used in quantities of up to 2 wt. %, based on TPU, as so-called chain terminators. For example, monoamines such as butylamine and dibutylamine, octylamine, stearyl amine, N-methyl stearyl amine, pyrrolidine, piperidine or cyclohexylamine, monoalcohols such as butanol, 2-ethyl hexanol, octanol, dodecanol, stearyl alcohol, the various amyl alcohols, cyclohexanol and ethylene glycol monomethyl ethers are suitable.

The thermoplastic polyurethane elastomers according to the invention can contain auxiliary substances and additives (g) in quantities of up to maximum 20 wt. %, based on the total quantity of TPU. Typical auxiliary substances and additives are lubricants and mould release agents such as fatty acid esters, the metal soaps thereof, fatty acid amides, fatty acid ester amides and silicon compounds, anti-blocking agents, inhibitors, stabilizers against hydrolysis, light, heat and discoloration, dyes, pigments, inorganic and/or organic fillers, plasticizers, such as phosphates, phthalates, adipates, sebacates and alkylsulfonic acid esters, fungistatically and bacteriostatically active substances, and fillers and mixtures thereof and reinforcing agents. Reinforcing agents are in particular fibrous reinforcing agents such as e.g. inorganic fibers which are produced in accordance with the prior art and can also be used with a size. More detailed information on the named auxiliary substances and additives can be found in the specialist literature, for example the monograph by J. H. Saunders and K. C. Frisch “High Polymers”, volume XVI, Polyurethane, parts 1 and 2, Verlag Interscience Publishers 1962 and 1964, the Taschenbuch für Kunststoff-Additive by R. Gachter and H. Müller (Hanser Verlag Munich 1990) or DE-A 29 01 774.

To produce the TPUs according to the invention, components (a), (b), (c) and optionally (f) are reacted in the presence of the flame retardant according to the invention (d) and optionally catalysts (e) and the auxiliary substances and/or additives (g) in such quantities that the equivalence ratio of NCO groups of diisocyanates (a) to the sum of components (b), (c), (d) and (f) containing Zerewitinoff-active hydrogen atoms is 0.9:1 to 1.1:1. The phosphine oxide of flame retardant (d) is thereby in each case present during the reaction of structure components (a), (b) and (c), whilst the melamine derivative can also be subsequently added to the TPU.

The self-extinguishing TPUs according to the invention usually contain, in each case based on the total quantity of TPU, 0.1 to 20 wt. %, preferably 1 to 12 wt. % phosphine oxide and 5 to 50 wt. %, preferably 10 to 40 wt. %, melamine derivative.

The TPU molding compositions according to the invention are self-extinguishing, do not produce droplets and do not produce droplets when burning, and have good mechanical properties and processing properties.

The TPU according to the invention can optionally be further processed, e.g. by heating the TPU to produce sheets or blocks, by reducing or granulating in shredders or mills, by venting and granulating with melting. The TPU is preferably passed through a unit for continuous venting and strand formation. This unit can be e.g. a multi-screw extruder (ZSK).

The TPUs according to the invention are preferably used to produce injection-molded articles and extrusion articles.

The invention will be explained in greater detail by means of the following examples.

### EXAMPLES

The following abbreviations are used:

| | |
|---|---|
| TERATHANE | polyether with a molecular weight of Mₙ = 1000 |
| 1000 | g/mol; product from Du Pont de Nemours |
| MDI | methylene-4,4′-(phenylisocyanate) |
| IHPO | isobutyl-bis(hydroxypropyl)-phosphine oxide, |
| | flame retardant |
| BDO | 1,4-butanediol |
| IRGANOX 1010 | tetrakis(methylene-(3,5-di-tert-butyl-4- |
| | hydroxycinnamate)methane from Ciba Specialty |
| | Chemicals Inc. |
| LICOWAX C | release agent from Clariant Würtz GmbH |
| MC | melamine cyanurate, flame retardant |
| BDP | bisphenol A diphenyl phosphate, oligomer mixture |
| EXOLIT OP 910 | flame retardant based on phosphonate from Clariant |
| | GmbH (without Zerewitinoff-active hydrogen atoms) |

### Example 1

### Reference

A TPU molding composition with a Shore A hardness of 85 was produced. A mixture of 1159 g TERATHANE 1000, 139 g BDO, 110 g EXOLIT OP 910, 110 g BDP, 7 g IRGANOX 1010 and 10 g LICOWAX C was heated to 160° C. with stirring using a paddle mixer at a speed of 500 revolutions per minute (rpm). 684 g MDI were added. It was then stirred for 110 seconds and the TPU poured out. The material was re-treated for 30 minutes at 80° C. The finished TPU was chopped, pelleted and further processed.

### Example 2

### Reference

A TPU molding composition with a Shore A hardness of 85 was produced. A mixture of 1159 g TERATHANE 1000, 139 g BDO, 220 g EXOLIT OP 910, 7 g IRGANOX 1010 and 10 g LICOWAX C was heated to 160° C. with stirring using a paddle stirrer at a speed of 500 revolutions per minute (rpm). 684 g MDI were added. It was stirred for 110 seconds and the TPU poured out. The material was re-treated for 30 minutes at 80° C. The finished TPU was chopped, pelleted and further processed.

### Example 3

### According to the Invention

TERATHANE 1000 (650 g/min) in which BDP (10 wt. % based on the total quantity of TPU), IRGANOX 1010 (0.4 wt. % based on the total quantity of TPU) and tin dioctoate (100 ppm based on the quantity of TERATHANE 1000) were dissolved, was heated to 180° C. and fed continuously by means of a gear pump into the first housing of a ZSK 53 (twin-screw extruder from Werner & Pfleiderer).

Butanediol (98 g/min) and IHPO (51 g/min; 60° C.) were fed continuously into the same housing together with LICOWAX C (5 g/min; 0.4 wt. % based on the total quantity of TPU).

DESMODUR 44 M (461 g/min) was fed continuously into housing 3.

Housings 1 to 3 of the extruder were heated to 80° C. and housings 4 to 8 heated to 220 to 230° C., whilst the last 4 housings were cooled. The screw speed was 290 rpm.

At the end of the screw, the hot melt was removed as a strand, cooled in the water bath and pelleted.

### Example 4

### According to the Invention

TERATHANE 1000 (600 g/min) in which IRGANOX 1010 (0.4 wt. % based on the total quantity of TPU) and tin dioctoate (100 ppm based on the quantity of TERATHANE 1000) were dissolved, was heated to 180° C. and fed continuously by means of a gear pump into the first housing of a ZSK 53 (twin-screw extruder from Werner & Pfleiderer).

Butanediol (106 g/min) and IHPO (52 g/min; 60° C.) were fed continuously into the same housing together with LICOWAX C (5 g/min; 0.4 wt. % based on the total quantity of TPU).

DESMODUR 44 M (508 g/min) was fed continuously into housing 3. Housings 1 to 3 of the extruder were heated to 80° C. and housings 4 to 8 to 220 to 230° C., whilst the last 4 housings were cooled. The screw speed was 290 rpm.

At the end of the screw, the hot melt was removed as a strand, cooled in the water bath and pelleted.

### Example 5

### According to the Invention

TERATHANE 1000 (550 g/min) in which IRGANOX 1010 (0.4 wt. % based on the total quantity of TPU) and tin dioctoate (100 ppm based on the quantity of TERATHANE 1000) were dissolved, was heated to 180° C. and fed continuously by means of a gear pump into the first housing of a ZSK 53 (twin-screw extruder from Werner & Pfleiderer).

Butanediol (107 g/min) and IHPO (78 g/min; 60° C.) were fed continuously into the same housing together with LICOWAX C (5 g/min; 0.4 wt. % based on the total quantity of TPU).

DESMODUR 44 M (517 g/min) was then fed continuously into housing 3.

Housings 1 to 3 of the extruder were heated to 80° C. and housings 4 to 8 heated to 220 to 230° C., whilst the last 4 housings were cooled. The screw speed was 290 rpm.

At the end of the screw, the hot melt was removed as a strand, cooled in the water bath and pelleted.

Re-Extrusion

MC (for information on quantities see Table 1) was added to the TPU pellets produced in the examples. It was re-extruded on an extruder of type DSE 25, 4 Z, 360 Nm which has the following structure:
1. cold feed section with conveyor elements,
2. first heating section (175° C.) with first kneading section,
3. second heating section (185° C.) with conveyor element and second kneading section,
4. third heating section (190° C.) with kneading section, conveyor element and vacuum venting,
5. cross-head (195°) and die (190° C.)

at a conveyor rate of 10 kg/h at a speed of 220 rpm and then reprocessed to pellets with a strand pelletizer.

Cable Production

The re-extruded pellets were processed on an extruder with incorporation of a three-wire polypropylene (PP)-based cable to corresponding cable structures. The total cable diameter was in all cases 7.8 mm. The mechanism was determined on the cables produced in this way in accordance with EN 60811-1-1 and the flame-resistant properties in accordance with UL-1581.

Determination of the Flame Retardant Properties

The flame retardant properties were determined in accordance with UL-1581, wherein the finished cable described above is flame-treated three times for one minute, wherein the cable passes the test if a paper pennant which is 250 mm above the cone of the flame, cannot be combusted and the after-burn time after the last flame application is less than one minute.

TABLE 1

| | | | | | | Elongation | | |
|---|---|---|---|---|---|---|---|---|
| | | | | | Tensile | at | | |
| | IHPO | MC | Phosphate | Phosphonate | strength | break | Extrusion | UL- |
| Ex. | (%) | (%) | (%) | (%) | (MPa) | (%) | quality | 1581 |
| R-1 | 0 | 25 | 5 | 5 | 21 | 430 | Not further tracked | |
| | | | | | | | because blooming too | |
| | | | | | | | great | |
| R-2 | 0 | 25 | 10 | 0 | 20 | 420 | Deposit on the | No |
| | | | | | | | die | pass |
| 3 | 4 | 25 | 10 | 0 | 25 | 376 | Good, | Pass |
| | | | | | | | homogenous | |
| 4 | 4 | 30 | 0 | 0 | 15 | 265 | Good, | Pass |
| | | | | | | | homogenous | |
| 5 | 6 | 27 | 0 | 0 | 18 | 312 | Good, | Pass |
| | | | | | | | homogenous | |

In Reference Example 1, a combination of melamine cyanurate with phosphate and phosphonate was used as the flame retardant. The mechanical properties are good. A solid, tacky coating, however, formed on the surface of the molding. This coating is not acceptable, so no further investigations were carried out.

In Reference Example 2, a phosphate was used in combination with melamine cyanurate. This TPU did not meet the flameproofing properties according to UL-1581. The extrusion quality was not acceptable due to a large deposit on the die head (“bearding”). Deposits lead to undesired knots on the surface of the cable.

In Example 3 according to the invention, a combination of a phosphate and a phosphine oxide with melamine cyanurate was used. The flame-retardant properties according to Ul-1581 were met with this flame-retardant combination. The TPU also has good extrusion quality and very good mechanical properties.

A combination of phosphine oxide with melamine cyanurate was used in Examples 4 and 5 according to the invention. The TPUs passed the flame test and exhibited a good extrusion quality.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. In a self-extinguishing thermoplastic polyurethane (“TPU”), the improvement comprising including as a flame retardant at least one organic incorporable phosphine oxide and at least one melamine derivative and optionally additional flame retardants and optionally other additives and/or auxiliary substances.

2. The self-extinguishing thermoplastic polyurethane according to claim 1, wherein the organic incorporable phosphine oxide has the formula (I): 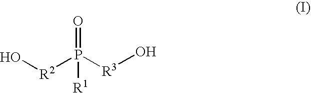
wherein,
R¹=H, branched or unbranched alkyl radicals with 1 to 12 carbon atoms, substituted or non-substituted aryl radicals with 6 to 20 carbon atoms, substituted or non-substituted aralkyl radicals with 6 to 30 carbon atoms, substituted or non-substituted alkaryl radicals with 6 to 30 carbon atoms,
R², R³=branched or unbranched alkylene radicals with 1 to 24 carbon atoms, substituted or non-substituted alkarylene radicals with 6 to 30 carbon atoms, wherein R² and R³ can be the same or different.

3. The self-extinguishing thermoplastic polyurethane according to claim 1, wherein the thermoplastic polyurethane contains about 2 to about 20 wt. % organic incorporable phosphine oxide and about 5 to about 50 wt. % melamine derivative, based on the total quantity of TPU.

4. A process for the production of a self-extinguishing thermoplastic polyurethane comprising reacting
A) an organic and/or modified organic diisocyanate (a) with
B) at least one polyhydroxyl compound (b), and
C) one or more chain extenders in the presence of
D) at least one flame retardant (d) and optionally
E) one or more catalysts (e),
F) one or more chain terminators (f)
G) auxiliary substances and/or additives (g)
wherein, at least one organic incorporable phosphine oxide and at least one melamine derivative, preferably melamine cyanurate and optionally additional flame retardants are used as the flame retardant (d).

5. In the production of one of an injection molded article and an extruded article, the improvement comprising including the self-extinguishing thermoplastic polyurethane according to claim 1.

6. The self-extinguishing thermoplastic polyurethane according to claim 1, wherein the thermoplastic polyurethane contains from about 2 to about 12 wt. % organic incorporable phosphine oxide and about 10 to about 40 wt. %, melamine derivative, based on the total quantity of TPU.

7. The process according to claim 4, wherein the at least one polyhydroxyl compound (b) comprises a difunctional polyhydroxyl compound.
